(19) United States
(12) Patent Application Publication
(10) Pub. No.: US 2021/0403009 A1
(43) Pub. Date: Dec. 30, 2021

(54) VEHICLE BREAKAGE HANDLING METHOD AND DEVICE IN AUTOMATED VEHICLE AND HIGHWAY SYSTEM (AVHS)

(71) Applicant: LG Electronics Inc., SEoul (KR)

(72) Inventors: Hansung LEE, Seoul (KR); Yongsoo PARK, Seoul (KR)

(21) Appl. No.: 16/499,103

(22) PCT Filed: Jul. 11, 2019
(86) PCT No.: PCT/KR2019/008572

§ 371 Date: Sep. 27, 2019

(51) Int. Cl. B60W 50/02; G07C 5/00; G06Q 50/30; G06Q 30/02; G06Q 10/00; B60W 40/08

(52) U.S. Cl. CPC B60W 50/0205; G07C 5/008; G06Q 50/30; B60W 2556/45; G06Q 10/20; B60W 40/08; G06Q 2240/00; G06Q 30/0283

(57) ABSTRACT

Disclosed is a method for monitoring a sharing vehicle by a server in an Automated Vehicle and Highway System (AVHS). According to an embodiment of the present disclosure, the method may include generating initial state data and operating state data of the sharing vehicle, determining whether the sharing vehicle is broken by comparing the initial state data and the operating state data, and transmitting a feedback to the sharing vehicle based on the determination. In doing so, a situation where a breakage occurs in the vehicle may be recognized, expense to be paid by a user may be reduced, and unnecessary conflicts between an owner of the vehicle and the user may be reduced. One or more of an autonomous vehicle, a user terminal, and a server of the present disclosure may be linked to an Artificial Intelligence (AI) module, an Unmanned Aerial Vehicle (UAV) robot, an Augmented Reality (AR) device, a Virtual Reality (VR) device, a 5G service-related device, etc.

### TECHNICAL FIELD

The present disclosure relates to an Automated Vehicle and Highway System (AVHS), and more particularly to a method and a device for monitoring a breakage in a vehicle and minimizing damage upon occurrence of the breakage.

### BACKGROUND ART

Vehicles can be classified into an internal combustion engine vehicle, an external composition engine vehicle, a gas turbine vehicle, an electric vehicle, etc. according to types of motors used therefor.

An autonomous vehicle refers to a self-driving vehicle that can travel without an operation of a driver or a passenger, and automated vehicle & highway systems refer to systems that monitor and control the autonomous vehicle such that the autonomous vehicle can perform self-driving.

### SUMMARY OF THE INVENTION

An object of the present disclosure is to provide a remote driving method using another autonomous vehicle in automated vehicle & highway systems.

Another object of the present disclosure is to provide a remote driving method using sensor data of another autonomous vehicle in automated vehicle & highway systems.

It will be appreciated by persons skilled in the art that the objects that could be achieved with the present disclosure are not limited to what has been particularly described hereinabove and the above and other objects that the present disclosure could achieve will be more clearly understood from the following detailed description.

In one aspect of the present disclosure, a remote driving method using another autonomous device of a network in automated vehicle & highway systems includes: transmitting, to a second device, a remote driving request message, when a message indicating impossibility of communication between a first device and a terminal connected to the network is received from the terminal; receiving, from the second device, a success response message for establishment of communication for remote driving of the first device; and transmitting, to the first device, a remote driving start message, wherein the remote driving request message may include positional information of the first device, and the second device may move on the basis of the positional information and traces the first device.

Further, the remote driving method may further include receiving a failure response message as a response to the remote driving request message if the second device is not able to move on the basis of the positional information of the first device or fails in tracing the first device.

Further, the remote driving request message may include a direct communication identifier of the first device, and the first device may be traced using the direct communication identifier of the first device through a direct communication method.

Further, the remote driving request message may include a direct communication identifier of the second device, and the remote driving method may further include transmitting sensor data by the first device to the second device using the direct communication identifier of the second device.

Further, the remote driving method may further include transmitting, by the second device, a control message for remote driving to the first device on the basis of the sensor data.

In another aspect of the present disclosure, a remote driving method using another autonomous device of a network in automated vehicle & highway systems includes: transmitting, to a second device, a message for requesting sensor support, when a message indicating that first sensor data received by a terminal from a first device is not valid is received from the terminal connected to the network; receiving, from the second device, a success response message as a response to the message for requesting sensor support; and transmitting, to the terminal, the success response message, wherein the second device may transmit, to the terminal, second sensor data capable of supporting a sensor indicated by the message indicating that the first sensor data is not valid.

Further, the message for requesting sensor support may include an Internet protocol (IP) address of the terminal, and the second device may be connected to the terminal which is the same as the first device using the IP address.

Further, the message for requesting sensor support may include positional information and driving direction information of the first device, and the second device may move to a position for generating the valid second sensor data on the basis of the positional information and the driving direction information.

Further, the terminal may determine whether the second sensor data is valid, and when the second sensor data is determined to be invalid, the network may receive the message representing that the first sensor data is not valid again.

Further, the terminal may determine whether the second sensor data is valid, and based on the second sensor data determined to be valid, the terminal may complement the first sensor data using the second sensor data.

In another aspect of the present disclosure, a remote driving method using another autonomous device of a network in automated vehicle & highway systems includes: transmitting, to a terminal, a message for requesting information about an area having communication quality allowing remote driving for the first device when it is determined that remote driving for the first device is not possible through a communication quality report received from the first device; receiving, from the terminal, area information as a response to the message for requesting information about an area having communication quality allowing remote driving for the first device; and transmitting, to a second device, a remote driving request message, wherein the second device may move the first device on the basis of the area information through remote driving.

Further, the area information may have priority based on positional information of the first device.

Further, the first device and the second device may communicate with at least one of a mobile terminal, the network and an autonomous vehicle other than the first device and the second device.

According to an embodiment of the present disclosure, remote driving can be performed using another autonomous vehicle in automated vehicle & highway systems.

In addition, according to an embodiment of the present disclosure, remote driving can be performed using sensor data of another autonomous vehicle.

It will be appreciated by persons skilled in the art that the effects that could be achieved with the present disclosure are not limited to what has been particularly described hereinabove and the above and other effects that the present disclosure could achieve will be more clearly understood from the following detailed description.

### DISCLOSURE

### Technical Problem

One object of the present disclosure is to propose a method and a device for monitoring a vehicle when the vehicle is used for a vehicle sharing service in an Automated Vehicle and Highway System (AVHS).

Another object of the present disclosure is to provide a method and a device for, when a result of the monitoring of the vehicle shows occurrence of a breakage in the vehicle, controlling a device to minimize damage and providing a user guide.

Yet another object of the present disclosure is to provide a method and a device for storing data on a situation, where the breakage occurs in the vehicle, and requesting payment of expense for the breakage in the vehicle.

The technical objects that can be achieved through the present disclosure are not limited to what has been particularly described hereinabove and other technical objects not described herein will be more clearly understood by persons skilled in the art from the following detailed description.

### Technical Solution

In one general aspect of the present disclosure, there is provided a method for monitoring a sharing vehicle by a server in an Automated Vehicle and Highway System (AVHS), the method including: generating initial state data on the sharing vehicle; generating operating state data on the sharing vehicle; determining as to whether the sharing vehicle is broken, by comparing the initial state data and the operating state data; and transmitting a feedback to the sharing vehicle based on the determination.

The method may further include receiving information on a state prior to operation from the sharing vehicle, wherein the information on the state prior to the operation may be acquired by at least one device of the sharing vehicle, and the initial state data is generated based on information on the state prior to the operation.

The method may further include receiving information on an in-operation state from the sharing vehicle, wherein the operating state data is generated based on the information on the in-operation state.

The method may further include receiving information on an in-operation state from the sharing vehicle, wherein the operating state data is generated based on the information on the in-operation state.

The method may further include, when a breakage occurs in the sharing vehicle, storing comparison data between the initial state data and the operating state data; and storing the comparison data.

The feedback may include a request to diagnose a broken device.

The method may further include: receiving a diagnosis result in response to the request to diagnose the broken device; and, based on a result of the diagnosis, transmitting control information on the broken device to the sharing vehicle.

The feedback further may further include a user guide regarding the broken device.

The method may further include receiving, from the sharing vehicle, data on monitoring as to whether a user takes an action in accordance with the user guide.

The data on the monitoring may be used to calculate expense for the broken device.

The feedback further may further include a request to pay expense for the broken device.

The request to pay the expense for the broken device may be forwarded by the sharing vehicle to a user terminal.

The method may further include, when the request to pay the expense for the broken device is not approved, setting restriction on use of the sharing vehicle.

The sharing vehicle may communicate with at least one of a mobile terminal, a network, or an autonomous vehicle other than the sharing vehicle.

In yet another embodiment of the present disclosure, there is provided a method for monitoring a sharing vehicle by the sharing vehicle in an Automated Vehicle and Highway System (AVHS), the method including: generating initial state data on the sharing vehicle; generating operating state data on the sharing vehicle; determining as to whether the sharing vehicle is broken, by comparing the initial state data and the operating state data; and transmitting a feedback to a user based on the determination.

The initial state data may be generated based on information on a state prior to operation acquired by at least one device of the sharing vehicle.

The method may further include transmitting the initial state data to a user terminal.

The method may further include, when a breakage occurs in the sharing vehicle, storing comparison data between the initial state data and the operating state data.

The feedback may include a user guide regarding a broken device

The feedback may include a request to pay expense for the broken device.

The method may further include transmitting, to a user terminal, the request to pay the expenses for the broken device.

The method may further include, when the request to pay the expense for the broken device is not approved, setting restriction on use of the sharing vehicle.

In yet another general aspect of the present disclosure, there is provided a server for monitoring a sharing vehicle in an Automated Vehicle and Highway System (AVHS), the server including: a communication system configured to transmit and receive data with the sharing vehicle and a user; a database system configured to store initial state data and operating state data regarding the sharing vehicle, which is generated based on data received through the communication system; a determination system configured to determine whether the sharing vehicle is broken, by comparing the initial state data and the operating state data; and a control system for controlling a feedback on the sharing vehicle based on a result of the determination by the determination system.

In yet another general aspect of the present disclosure, there is provided a device for monitoring a sharing vehicle in an Automated Vehicle and Highway System (AVHS), the device including: a communication device configured to communicate with another device; a memory configured to store data; and a processor functionally connected to the communication device and the memory, wherein the processor is configured to generate initial state data of the sharing vehicle, generate operating state data of the sharing vehicle, determine whether the sharing vehicle is broken by comparing the initial state data and the operating state data, and instruct operation of the sharing vehicle based on the determination.

### Advantageous Effects

According to an embodiment of the present disclosure, as a vehicle breakage is monitored in an Automated Vehicle and Highway System (AVHS), a notification may be provided to a user, a user guide may be provided, a control operation may be performed to prevent an additional damage, and a recovery cost may be reduced.

In addition, according to an embodiment of the present disclosure, as objective evidence regarding a vehicle breakage situation is secured, conflicts and costs regarding a vehicle breakage may e reduced.

The effects that can be achieved through the present disclosure are not limited to what has been particularly described hereinabove and other advantages of the present disclosure will be more clearly understood by persons skilled in the art from the following detailed description.

### DESCRIPTION OF DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present disclosure.

FIG. 6 is a control block diagram of the vehicle according to an embodiment of the present disclosure.

FIG. 7 is a control block diagram of an autonomous device according to an embodiment of the present disclosure.

FIG. 8 is a diagram showing a signal flow in an autonomous vehicle according to an embodiment of the present disclosure.

FIG. 9 is a diagram illustrating the interior of a vehicle according to an embodiment of the present disclosure.

FIG. 10 is a block diagram referred to in description of a cabin system for a vehicle according to an embodiment of the present disclosure.

FIG. 11 is a diagram referred to in description of a usage scenario of a user according to an embodiment of the present disclosure.

FIG. 12 shows an example of a flowchart of operations of a vehicle, to which the method and the embodiment proposed in the present specification can be applied.

FIG. 13 shows an example of a flowchart of signaling and operations between a vehicle breakage handling server and a vehicle according to an embodiment of the present disclosure.

FIG. 14 shows an example of a flowchart in which a vehicle breakage handling server (or system), to which the method and the embodiment proposed in the present specification can be applied, instructs a vehicle to operate responsive to a vehicle breakage.

FIG. 15 is an example of a diagram showing a configuration of a vehicle breakage handling server to which the method and the embodiment proposed in the present specification can be applied.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present disclosure would unnecessarily obscure the gist of the present disclosure, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

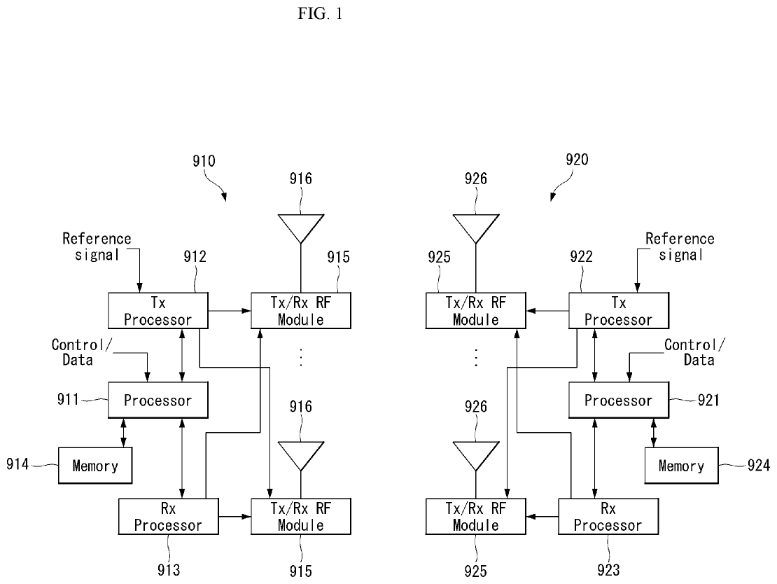

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

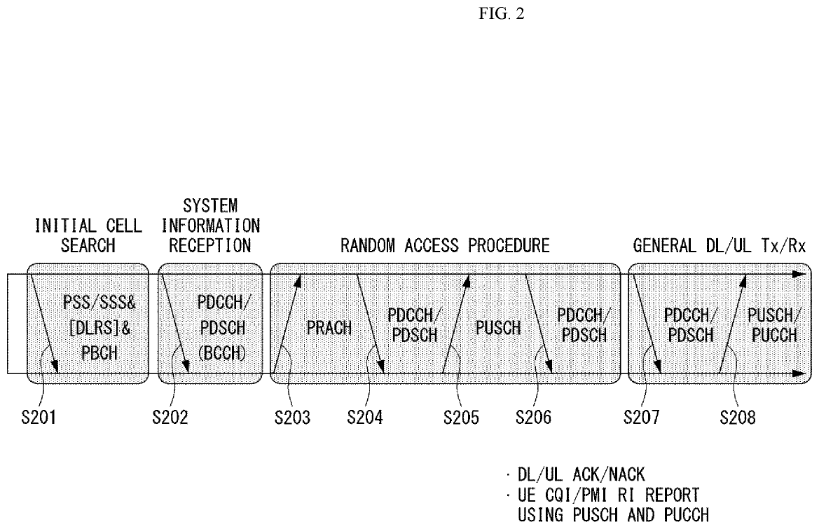

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

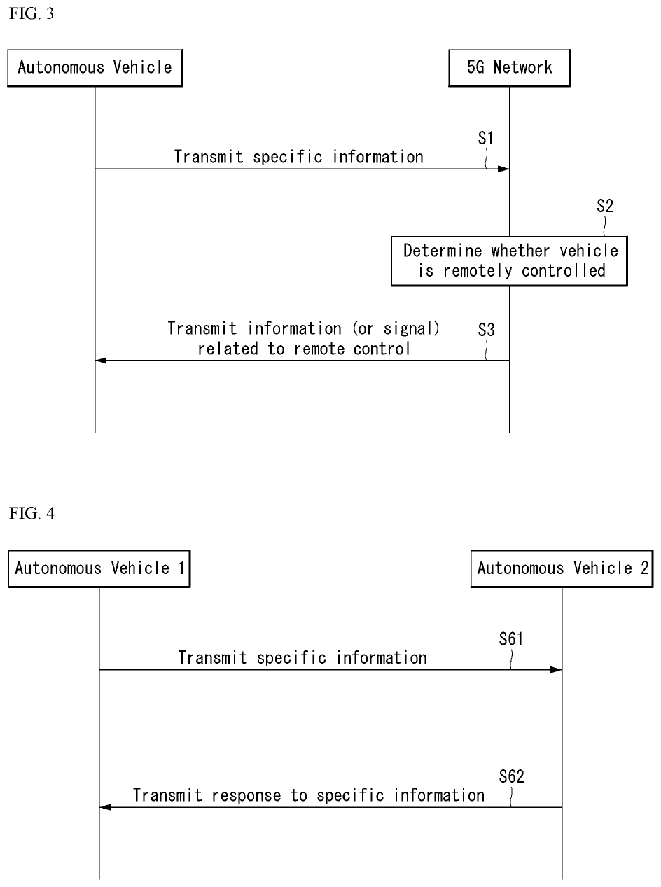

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present disclosure which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present disclosure which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present disclosure which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

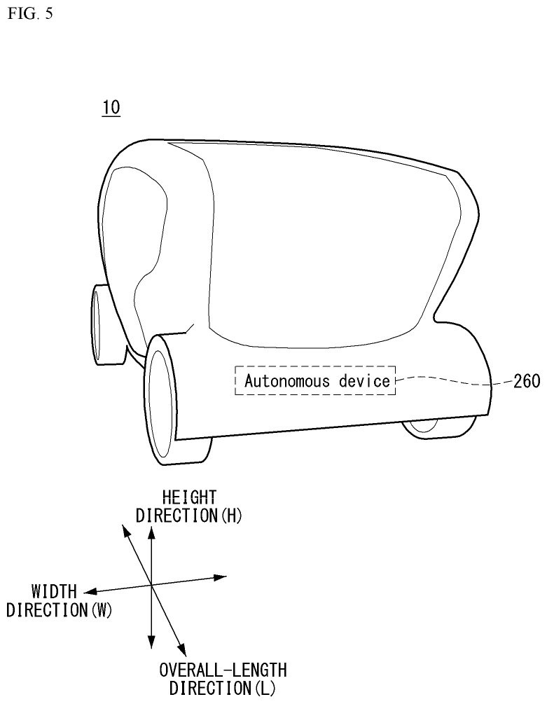

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present disclosure which will be described later and applied or can complement the methods proposed in the present disclosure to make technical features of the methods concrete and clear.

Driving

(1) Exterior of Vehicle

FIG. 5 is a diagram showing a vehicle according to an embodiment of the present disclosure.

Referring to FIG. 5, a vehicle 10 according to an embodiment of the present disclosure is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

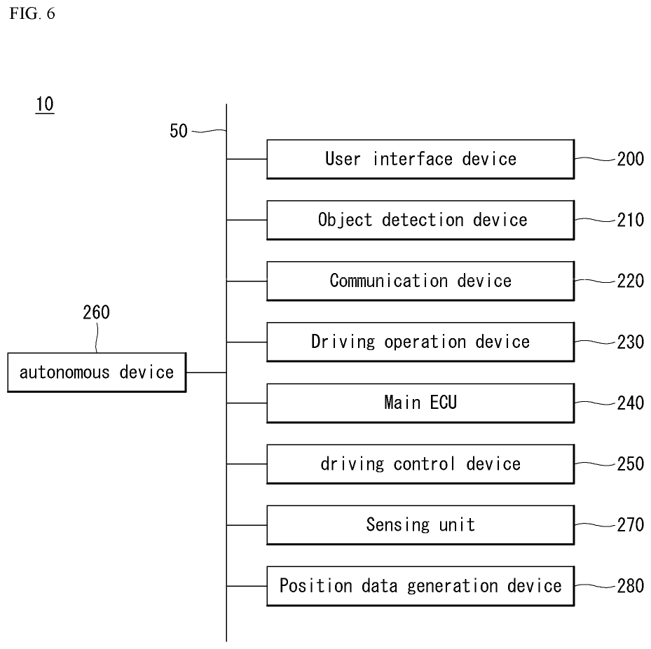

FIG. 6 is a control block diagram of the vehicle according to an embodiment of the present disclosure.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3 Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position data generation device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

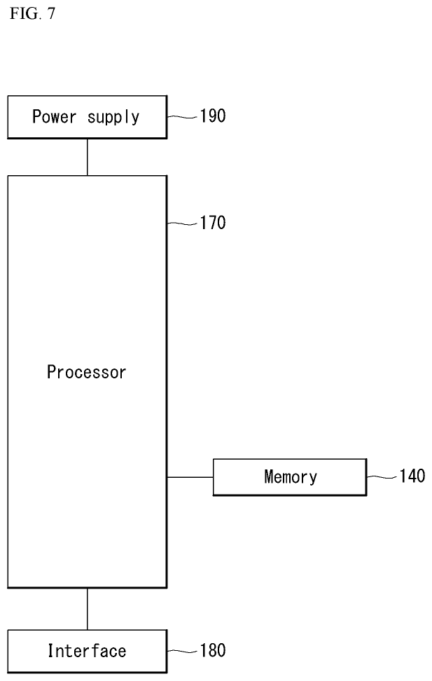

FIG. 7 is a control block diagram of the autonomous device according to an embodiment of the present disclosure.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

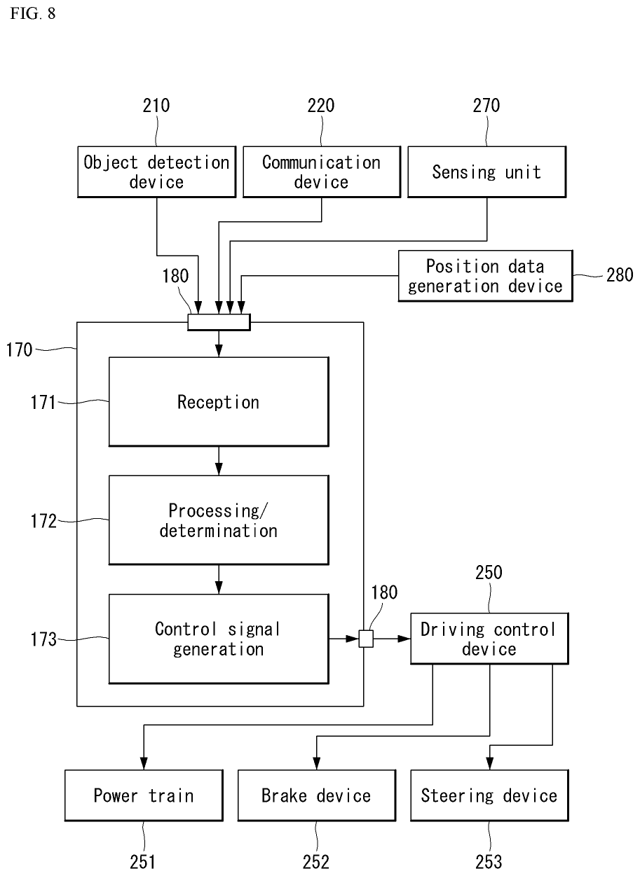

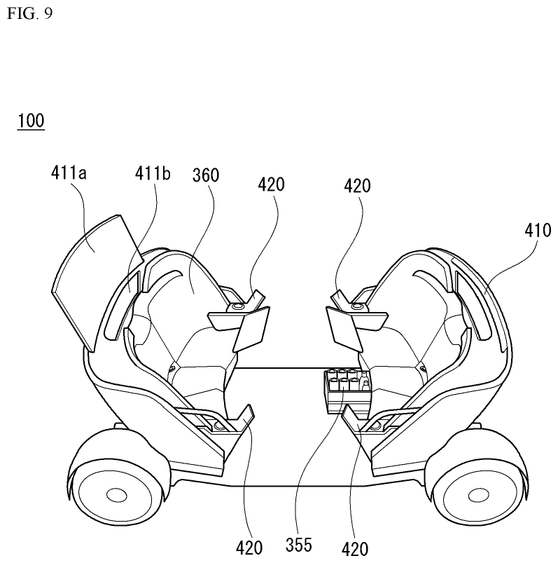

FIG. 8 is a diagram showing a signal flow in an autonomous vehicle according to an embodiment of the present disclosure.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Cabin

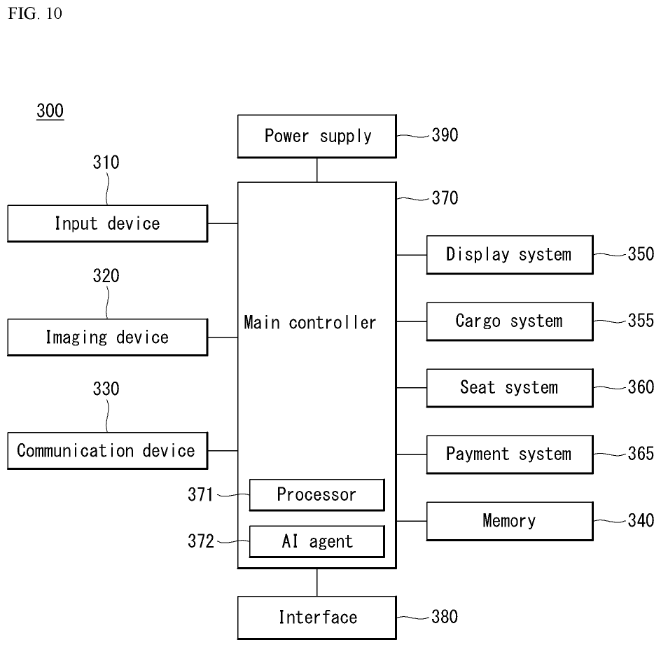

FIG. 9 is a diagram showing the interior of the vehicle according to an embodiment of the present disclosure. FIG. 10 is a block diagram referred to in description of a cabin system for a vehicle according to an embodiment of the present disclosure.

(1) Components of Cabin

Referring to FIGS. 9 and 10, a cabin system 300 for a vehicle (hereinafter, a cabin system) can be defined as a convenience system for a user who uses the vehicle 10. The cabin system 300 can be explained as a high-end system including a display system 350, a cargo system 355, a seat system 360 and a payment system 365. The cabin system 300 may include a main controller 370, a memory 340, an interface 380, a power supply 390, an input device 310, an imaging device 320, a communication device 330, the display system 350, the cargo system 355, the seat system 360 and the payment system 365. The cabin system 300 may further include components in addition to the components described in this specification or may not include some of the components described in this specification according to embodiments.

1) Main Controller

The main controller 370 can be electrically connected to the input device 310, the communication device 330, the display system 350, the cargo system 355, the seat system 360 and the payment system 365 and exchange signals with these components. The main controller 370 can control the input device 310, the communication device 330, the display system 350, the cargo system 355, the seat system 360 and the payment system 365. The main controller 370 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The main controller 370 may be configured as at least one sub-controller. The main controller 370 may include a plurality of sub-controllers according to an embodiment. The plurality of sub-controllers may individually control the devices and systems included in the cabin system 300. The devices and systems included in the cabin system 300 may be grouped by function or grouped on the basis of seats on which a user can sit.

The main controller 370 may include at least one processor 371. Although FIG. 6 illustrates the main controller 370 including a single processor 371, the main controller 371 may include a plurality of processors. The processor 371 may be categorized as one of the above-described sub-controllers.

The processor 371 can receive signals, information or data from a user terminal through the communication device 330. The user terminal can transmit signals, information or data to the cabin system 300.

The processor 371 can identify a user on the basis of image data received from at least one of an internal camera and an external camera included in the imaging device. The processor 371 can identify a user by applying an image processing algorithm to the image data. For example, the processor 371 may identify a user by comparing information received from the user terminal with the image data. For example, the information may include at least one of route information, body information, fellow passenger information, baggage information, position information, preferred content information, preferred food information, disability information and use history information of a user.

The main controller 370 may include an artificial intelligence (AI) agent 372. The AI agent 372 can perform machine learning on the basis of data acquired through the input device 310. The AI agent 371 can control at least one of the display system 350, the cargo system 355, the seat system 360 and the payment system 365 on the basis of machine learning results.

2) Essential Components

The memory 340 is electrically connected to the main controller 370. The memory 340 can store basic data about units, control data for operation control of units, and input/output data. The memory 340 can store data processed in the main controller 370. Hardware-wise, the memory 340 may be configured using at least one of a ROM, a RAM, an EPROM, a flash drive and a hard drive. The memory 340 can store various types of data for the overall operation of the cabin system 300, such as a program for processing or control of the main controller 370. The memory 340 may be integrated with the main controller 370.

The interface 380 can exchange signals with at least one electronic device included in the vehicle 10 in a wired or wireless manner. The interface 380 may be configured using at least one of a communication module, a terminal, a pin, a cable, a port, a circuit, an element and a device.

The power supply 390 can provide power to the cabin system 300. The power supply 390 can be provided with power from a power source (e.g., a battery) included in the vehicle 10 and supply the power to each unit of the cabin system 300. The power supply 390 can operate according to a control signal supplied from the main controller 370. For example, the power supply 390 may be implemented as a switched-mode power supply (SMPS).

The cabin system 300 may include at least one printed circuit board (PCB). The main controller 370, the memory 340, the interface 380 and the power supply 390 may be mounted on at least one PCB.

3) Input Device

The input device 310 can receive a user input. The input device 310 can convert the user input into an electrical signal. The electrical signal converted by the input device 310 can be converted into a control signal and provided to at least one of the display system 350, the cargo system 355, the seat system 360 and the payment system 365. The main controller 370 or at least one processor included in the cabin system 300 can generate a control signal based on an electrical signal received from the input device 310.

The input device 310 may include at least one of a touch input unit, a gesture input unit, a mechanical input unit and a voice input unit. The touch input unit can convert a user's touch input into an electrical signal. The touch input unit may include at least one touch sensor for detecting a user's touch input. According to an embodiment, the touch input unit can realize a touch screen by integrating with at least one display included in the display system 350. Such a touch screen can provide both an input interface and an output interface between the cabin system 300 and a user. The gesture input unit can convert a user's gesture input into an electrical signal. The gesture input unit may include at least one of an infrared sensor and an image sensor for detecting a user's gesture input. According to an embodiment, the gesture input unit can detect a user's three-dimensional gesture input. To this end, the gesture input unit may include a plurality of light output units for outputting infrared light or a plurality of image sensors. The gesture input unit may detect a user's three-dimensional gesture input using TOF (Time of Flight), structured light or disparity. The mechanical input unit can convert a user's physical input (e.g., press or rotation) through a mechanical device into an electrical signal. The mechanical input unit may include at least one of a button, a dome switch, a jog wheel and a jog switch. Meanwhile, the gesture input unit and the mechanical input unit may be integrated. For example, the input device 310 may include a jog dial device that includes a gesture sensor and is formed such that it can be inserted/ejected into/from a part of a surrounding structure (e.g., at least one of a seat, an armrest and a door). When the jog dial device is parallel to the surrounding structure, the jog dial device can serve as a gesture input unit. When the jog dial device is protruded from the surrounding structure, the jog dial device can serve as a mechanical input unit. The voice input unit can convert a user's voice input into an electrical signal. The voice input unit may include at least one microphone. The voice input unit may include a beam forming MIC.

4) Imaging Device

The imaging device 320 can include at least one camera. The imaging device 320 may include at least one of an internal camera and an external camera. The internal camera can capture an image of the inside of the cabin. The external camera can capture an image of the outside of the vehicle. The internal camera can acquire an image of the inside of the cabin. The imaging device 320 may include at least one internal camera. It is desirable that the imaging device 320 include as many cameras as the number of passengers who can ride in the vehicle. The imaging device 320 can provide an image acquired by the internal camera. The main controller 370 or at least one processor included in the cabin system 300 can detect a motion of a user on the basis of an image acquired by the internal camera, generate a signal on the basis of the detected motion and provide the signal to at least one of the display system 350, the cargo system 355, the seat system 360 and the payment system 365. The external camera can acquire an image of the outside of the vehicle. The imaging device 320 may include at least one external camera. It is desirable that the imaging device 320 include as many cameras as the number of doors through which passengers ride in the vehicle. The imaging device 320 can provide an image acquired by the external camera. The main controller 370 or at least one processor included in the cabin system 300 can acquire user information on the basis of the image acquired by the external camera. The main controller 370 or at least one processor included in the cabin system 300 can authenticate a user or acquire body information (e.g., height information, weight information, etc.), fellow passenger information and baggage information of a user on the basis of the user information.

5) Communication Device

The communication device 330 can exchange signals with external devices in a wireless manner. The communication device 330 can exchange signals with external devices through a network or directly exchange signals with external devices. External devices may include at least one of a server, a mobile terminal and another vehicle. The communication device 330 may exchange signals with at least one user terminal. The communication device 330 may include an antenna and at least one of an RF circuit and an RF element which can implement at least one communication protocol in order to perform communication. According to an embodiment, the communication device 330 may use a plurality of communication protocols. The communication device 330 may switch communication protocols according to a distance to a mobile terminal.

For example, the communication device can exchange signals with external devices on the basis of C-V2X (Cellular V2X). For example, C-V2X may include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present disclosure can exchange signals with external devices using only one of C-V2X and DSRC. Alternatively, the communication device of the present disclosure can exchange signals with external devices using a hybrid of C-V2X and DSRC.

6) Display System

The display system 350 can display graphic objects. The display system 350 may include at least one display device. For example, the display system 350 may include a first display device 410 for common use and a second display device 420 for individual use.

6.1) Common Display Device

The first display device 410 may include at least one display 411 which outputs visual content. The display 411 included in the first display device 410 may be realized by at least one of a flat panel display, a curved display, a rollable display and a flexible display. For example, the first display device 410 may include a first display 411 which is positioned behind a seat and formed to be inserted/ejected into/from the cabin, and a first mechanism for moving the first display 411. The first display 411 may be disposed such that it can be inserted/ejected into/from a slot formed in a seat main frame. According to an embodiment, the first display device 410 may further include a flexible area control mechanism. The first display may be formed to be flexible and a flexible area of the first display may be controlled according to user position. For example, the first display device 410 may be disposed on the ceiling inside the cabin and include a second display formed to be rollable and a second mechanism for rolling or unrolling the second display. The second display may be formed such that images can be displayed on both sides thereof. For example, the first display device 410 may be disposed on the ceiling inside the cabin and include a third display formed to be flexible and a third mechanism for bending or unbending the third display. According to an embodiment, the display system 350 may further include at least one processor which provides a control signal to at least one of the first display device 410 and the second display device 420. The processor included in the display system 350 can generate a control signal on the basis of a signal received from at last one of the main controller 370, the input device 310, the imaging device 320 and the communication device 330.

A display area of a display included in the first display device 410 may be divided into a first area 411a and a second area 411b. The first area 411a can be defined as a content display area. For example, the first area 411 may display at least one of graphic objects corresponding to can display entertainment content (e.g., movies, sports, shopping, food, etc.), video conferences, food menu and augmented reality screens. The first area 411a may display graphic objects corresponding to traveling situation information of the vehicle 10. The traveling situation information may include at least one of object information outside the vehicle, navigation information and vehicle state information. The object information outside the vehicle may include information on presence or absence of an object, positional information of an object, information on a distance between the vehicle and an object, and information on a relative speed of the vehicle with respect to an object. The navigation information may include at least one of map information, information on a set destination, route information according to setting of the destination, information on various objects on a route, lane information and information on the current position of the vehicle. The vehicle state information may include vehicle attitude information, vehicle speed information, vehicle tilt information, vehicle weight information, vehicle orientation information, vehicle battery information, vehicle fuel information, vehicle tire pressure information, vehicle steering information, vehicle indoor temperature information, vehicle indoor humidity information, pedal position information, vehicle engine temperature information, etc. The second area 411b can be defined as a user interface area. For example, the second area 411b may display an AI agent screen. The second area 411b may be located in an area defined by a seat frame according to an embodiment. In this case, a user can view content displayed in the second area 411b between seats. The first display device 410 may provide hologram content according to an embodiment. For example, the first display device 410 may provide hologram content for each of a plurality of users such that only a user who requests the content can view the content.

6.2) Display Device for Individual Use

The second display device 420 can include at least one display 421. The second display device 420 can provide the display 421 at a position at which only an individual passenger can view display content. For example, the display 421 may be disposed on an armrest of a seat. The second display device 420 can display graphic objects corresponding to personal information of a user. The second display device 420 may include as many displays 421 as the number of passengers who can ride in the vehicle. The second display device 420 can realize a touch screen by forming a layered structure along with a touch sensor or being integrated with the touch sensor. The second display device 420 can display graphic objects for receiving a user input for seat adjustment or indoor temperature adjustment.

7) Cargo System

The cargo system 355 can provide items to a user at the request of the user. The cargo system 355 can operate on the basis of an electrical signal generated by the input device 310 or the communication device 330. The cargo system 355 can include a cargo box. The cargo box can be hidden in a part under a seat. When an electrical signal based on user input is received, the cargo box can be exposed to the cabin. The user can select a necessary item from articles loaded in the cargo box. The cargo system 355 may include a sliding moving mechanism and an item pop-up mechanism in order to expose the cargo box according to user input. The cargo system 355 may include a plurality of cargo boxes in order to provide various types of items. A weight sensor for determining whether each item is provided may be embedded in the cargo box.

8) Seat System

The seat system 360 can provide a user customized seat to a user. The seat system 360 can operate on the basis of an electrical signal generated by the input device 310 or the communication device 330. The seat system 360 can adjust at least one element of a seat on the basis of acquired user body data. The seat system 360 may include a user detection sensor (e.g., a pressure sensor) for determining whether a user sits on a seat. The seat system 360 may include a plurality of seats on which a plurality of users can sit. One of the plurality of seats can be disposed to face at least another seat. At least two users can set facing each other inside the cabin.

9) Payment System

The payment system 365 can provide a payment service to a user. The payment system 365 can operate on the basis of an electrical signal generated by the input device 310 or the communication device 330. The payment system 365 can calculate a price for at least one service used by the user and request the user to pay the calculated price.

(2) Autonomous Vehicle Usage Scenarios

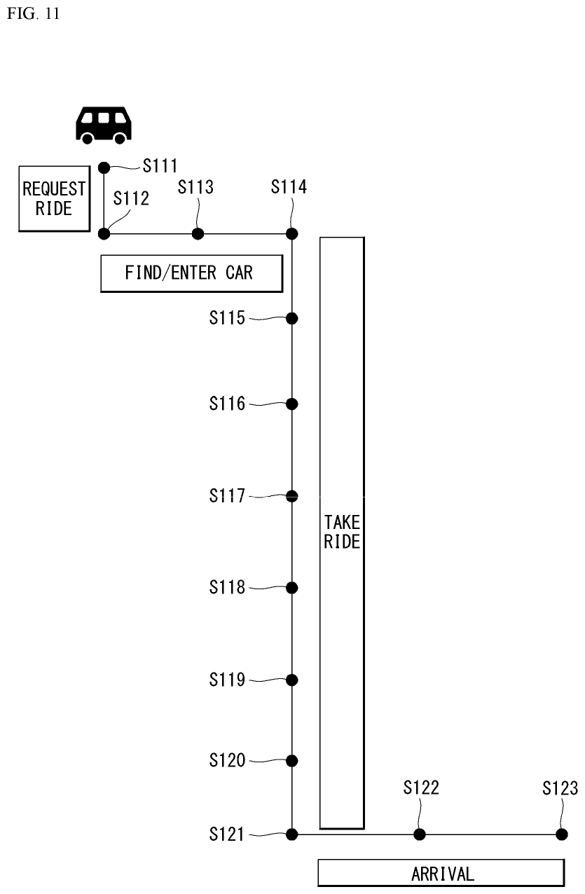

FIG. 11 is a diagram referred to in description of a usage scenario of a user according to an embodiment of the present disclosure.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

The above-describe 5G communication technology can be combined with methods proposed in the present disclosure which will be described later and applied or can complement the methods proposed in the present disclosure to make technical features of the present disclosure concrete and clear.

Hereinafter, various embodiments of the present disclosure will be described in detail with reference to the attached drawings.

Meanwhile, with the spread of shared economy, vehicle possession types have been diversified. As the way of consuming vehicles has changed from “possession” to “use”, a vehicle sharing service (or system) in which a user borrows a vehicle from an individual, a corporation, or the like for a short period of time has been widely on trend. The vehicle sharing service can be divided largely into ride sharing and car sharing. The ride sharing is sharing of a mobile service, which is a kind of service connecting a user and a provider of a mobile service (a vehicle, a driver, or the like). The car sharing is a kind of service for renting a vehicle.

For the vehicle sharing service (e.g., ride sharing, car sharing, etc.), feet management such as vehicle supply management, usage management, maintenance and repair, etc. may be required. In particular, since multiple users uses one vehicle, it may be very important to set a standard, an evidence, and the like in regard with determining which user is responsibility for a vehicle breakage. Further, a vehicle breakage occurring even without intervention of a vehicle owner or manager in an Automated Vehicle and Highway System (AVHS) may lead to a problem regarding who takes the responsibility for the breakage.

Hereinafter, the present specification proposes a vehicle control method in an AVHS, by which occurrence of a breakage of a vehicle used for a vehicle sharing service is monitored to minimize any other possible damage after the breakage or a damage triggering behavior, to request payment from a user, and to make provision for escape of the user.

In a case where an autonomous vehicle is used for a vehicle sharing service, a method for monitoring the vehicle to thereby determine occurrence of a breakage and handling the breakage may be considered.

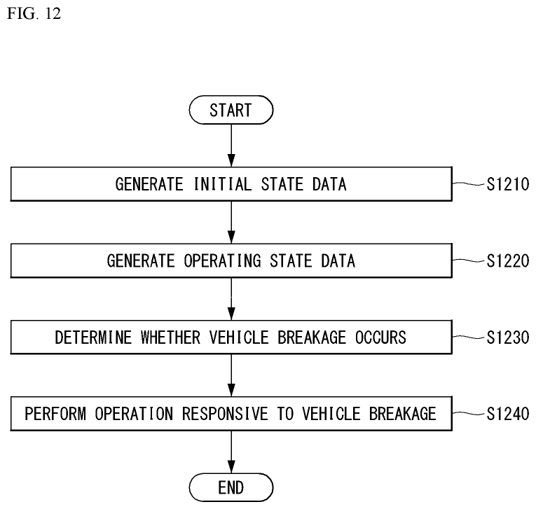

FIG. 12 shows an example of a flowchart of operations of a vehicle, to which the method and the embodiment proposed in the present specification can be applied. FIG. 12 is merely an example for convenience of explanation, and it does not limit the technical idea of the present disclosure.

Referring to FIG. 12, a vehicle may generate initial state data of a vehicle which is used as a basis of determining a breakage of the vehicle (S1210). The initial state data may indicate the vehicle's state prior to the occurrence of the breakage. The initial state data may prove that the vehicle's state prior to use was a normally operable state, and the initial state data may be used as an evidence to request expense or compensation upon the breakage of the vehicle.

The initial state data may be generated based on information acquired by at least one device included in the autonomous vehicle. A processor included in the vehicle may generate initial state data based on information acquired by at least one device included in the vehicle. For example, it is possible to acquire image data of captured exterior and interior of the vehicle, based on video data received from at least one of an internal camera or an external camera included in an imaging device 320 of a cabin system 300. In addition, information such as vehicle collision data, battery data, fuel data, tire pressure data, etc. may be acquired using a sensing unit 270 of the vehicle. Initial state data may be generated based on the acquired information such as the image data, the vehicle collision data, the battery data, the fuel data, the tire pressure data, etc. Alternatively, the acquired image itself may be set as initial state data.

The initial state data may be stored in a memory 340 of the cabin system of the vehicle or a memory 140 of an autonomous driving device. Alternatively, the initial state data may be stored in a database of an autonomous driving server or a vehicle sharing server via a network connected to the vehicle.

The initial state data may be transmitted to a user of a vehicle sharing service via the network connected to the vehicle. The initial state data may be transmitted directly to the user via the network connected to the vehicle. Alternatively, the initial state data may be transmitted after passing through the autonomous driving server or the vehicle driving server. A user may receive the initial state data of the vehicle using a user terminal (e.g., a mobile phone, a laptop computer, etc.), confirm a vehicle state, and use the vehicle. The confirmation by the user may be transmitted to the vehicle, the autonomous driving server and/or the vehicle sharing server via the network connected to the vehicle.

The vehicle may generate operating state data by monitoring a vehicle state during operation (S1220). The processor included in the vehicle may generate operating state data based on information acquired by at least one device included in the autonomous vehicle. For example, information on an in-operation vehicle state may be acquired using at least one device from among an object detection device 210 and a sensing unit 270 of an autonomous driving device 260 and the imaging device 320 of the cabin system 300. Operating state data may be generated based on the acquired information. Based on the generated initial state data and the operating state data, the vehicle may monitor whether a breakage occurs in the vehicle during operation.

The operating state data may be updated periodically, semi-persistently, or aperiodically. In a case where the operating state information is updated periodically or semi-persistently, the operating state data may be updated by periodically or semi-persistently receiving an in-operation vehicle state from at least one device included in the autonomous vehicle. In a case where the operating state data is updated aperiodically, the operating state data is updated by aperiodically receiving information on an in-operation vehicle state from at least one device included in the autonomous vehicle.

In the case where the operating state information is updated aperiodically, a triggering signal in response to the update request may be transmitted to the processor of the vehicle from the at least one device of the autonomous vehicle. For example, when a breakage occurs while the vehicle is in operation, a signal (e.g., a breakage notifying emergency alarm, an ACK, etc.) indicative of an abnormal operation (e.g., a breakage) may be transmitted from a broken device (or component. The signal (e.g., a breakage notifying emergency alarm, an ACK, etc.) indicative of an abnormal operation (e.g., a breakage) is a triggering signal to update operating state data and may be transmitted to the processor of the vehicle. Thereafter, information regarding occurrence of a breakage during operation of the vehicle may be received using a camera included in the object detection device, the imaging device, etc., of the vehicle, and the operating state data may be updated based on the information. In a specific example, when a collision with a nearby vehicle occurs while the vehicle is in operation, the sensing unit may recognize the collision and transmit an emergency alarm regarding the collision to the processor of the vehicle. Data on situations before and after the collision may be acquired using a camera included in the object detection device and/or the imaging device of the vehicle, and the operating state data may be updated aperiodically based on the acquired data.

In addition, after termination of the operation of the vehicle, data corresponding to a state at a timing of when the operation of the vehicle is terminated may be generated using the object detection device 210 and the sensing unit 270 of the autonomous vehicle 260, the imaging device 320 of the cabin system 300, etc., and the operating state data may be updated. The operating state data at the operation termination timing may be used to calculate a fee for use of a vehicle sharing service.

The operating state data may be stored in the memory 340 of the cabin system of the vehicle or in the memory 140 of the autonomous driving device. Alternatively, the operating state data may be stored in a database of the autonomous driving server or the vehicle sharing server via the network connected to the vehicle.

The vehicle may determine occurrence of a breakage of the vehicle by comparing the initial state data and the operating state data (S1230). The determination may be made by the processor of the vehicle. The comparison between the initial state data and the operating state data may be performed whenever the operating state data is generated or updated. That is, the comparison between the initial state data and broken state data may be performed periodically, semi-persistently, or aperiodically. Alternatively, the comparison between the initial state data and the operating state data may be performed only when a signal (e.g., a breakage notifying emergency alarm, an ACK, etc.) indicative of an abnormal operation (e.g., breakage) is received from a broken device (or component). In other words, although the operating state data is updated periodically, the initial state data and the operation state data can be compared when a signal indicative of an abnormal operation is received from a broken device.

When it is determined that the vehicle is broken after the comparison between the initial state data and the operating state data, the vehicle may operate in response to the breakage (S1240). When it is determined that the vehicle is broken, he processor of the vehicle may give an instruction to at least one device of the vehicle so as to perform an operation to prevent an additional possible breakage and minimize damage.

For example, when it is determined that a device (or component) in the vehicle is broken, the vehicle may perform control regarding the broken device (or component). The vehicle may perform diagnosis on the broken device (or component, and control the broken device (or component) based on the diagnosis. The diagnosis of the broken device (or component) may be performed by the processor of the autonomous driving device or one of controllers of devices. Or, a controller of each device may perform primary diagnosis and the processor of the autonomous driving device may perform secondary diagnosis. Or, a diagnosing system (or device) for performing diagnosis on the broken device may exist independently in the autonomous driving device. At this point, the diagnosing system may perform diagnosis not just on the broken device (or component), but also on every function related to operations of the AVHS, such as sensor, recognition, determination, control, HMI, etc. Based on the diagnosis, a control method for the broken device (or component) may be determined and a control operation may be performed.

In a specific example, when it is determined that a display device of the cabin system is broken, the diagnosing system may perform diagnosis on the display device. Whether to completely shut down power to the display device or whether to performing diagnosis after shutdown of the power for a predetermined period of time may be determined based on the diagnosis, and then a power control on the display device may be performed.

In another example, when it is determined that a device (or component) in the vehicle is broken, the vehicle may notify a user (occupant) of the breakage. In addition, in order to prevent an additional component breakage, a breakage minimizing method (e.g., user guide) may be notified to a user. The breakage minimizing method may be determined based on a result of the diagnosis. The breakage notification alarm and the user guide may be displayed through a display system 350 of the cabin system 300. Or, the breakage notification alarm and the user guide may be provided through an audio device in the vehicle. Or, the breakage notification alarm and the user guide may be provided through both the display device and the audio device.

When the user guide is provided, the vehicle may monitor the user's responsive behavior in accordance with the user guide. The monitoring ay be performed through the imaging device 320 of the cabin system. A result of the monitoring may be taken into consideration when expense for a broken device (or component) is calculated later. Specifically, an image of a user's behavior may be acquired using at least one camera of an internal camera or an external camera of the vehicle, and whether the user has taken a responsive action in accordance with the user guide may be determined based on the acquired image. When the user takes an appropriate action, expense reduction may be provided when a cost for repairing the broken device is calculated.

In another example, the processor of the vehicle may calculate a cost for repairing a broken device (or component) of the vehicle and inform the user of the repair cost. The repair cost may be calculated based on image data of the broken device and diagnosis of the broken device. Information on the calculated repair cost may be displayed through the display system 350 of the cabin system 300. Or, the information on the calculated repair cost may be provided through an audio device in the vehicle. Or, the information on the calculated repair cost may be provided through both the display device and the audio device. In addition, payment of the repair cost may be proceeded to through a payment system 365. Specifically, calculated repair cost may be displayed through the display device, and a message to request agreement from the user may be displayed. If the user inputs an agreement message through an input device 310, payment of the repair cost may be completed through the payment system. Or, a message for asking payment of repair cost may be transmitted to a user terminal via the network connected to the vehicle. If the user does not agree with the payment of the repair cost for the breakage, a message for a possible restriction on the use of the vehicle may be displayed. In addition, restrictions on a maximum speed, an available time to use, etc. of the vehicle may be set.

A specific example of a vehicle operating according to the above-described embodiment will be described.

It is possible to assume a case where an occupant in the vehicle spills water over the display device while the vehicle is in operation and a case where a window glass next to a seat is cracked by an impact. This assumption is merely an example to provide a better understanding of the present disclosure, and it does not limit the technical idea of the present disclosure.

Before use of the vehicle, initial state data on a vehicle state may be generated and stored in a memory. When an occupant starts to use the vehicle, an image on an operating state may be acquired using at least one of an internal camera or an external camera of the vehicle, and operating state data may be generated based on the acquired image. That is, at least one of the internal camera or the external camera of the vehicle may acquire an image of the occupant spilling water or cracking a side glass, and operating state data may be generated and updated based on the acquired image. The processor may compare the operating state data and the initial state data and determine that the display device and the side glass are broken. In addition, the image data and the operating state data regarding the breakage of the display device and the side glass may be additionally stored in the memory as an evidence to claim repair costs.

In response to the breakage of the display device and the side glass, the processor may shut down power to the display device and activate a protective film on the side glass. The processor may perform diagnosis on the display device. Whether to keep shutting down the power to the display device or to reactivate the power after a shutdown for a predetermined period of time may be determined based on the diagnosis. An amount of spilled water may be estimated through the image data acquired by the camera, and a timing of reactivating the display device may be determined based on the amount of spilled water and a time required to dry the display device. If the amount of spilled water exceeds a predetermined level, the display device may not be reactivated by any means.

In order to inform a user the fact that water is spilled over the display device and causes a breakage, a breakage notification and a user guide may be provided through another display device or an audio device in the vehicle. A notification such as “Power is off because water is spilled over a display device. Please follow user guide” may be provided. The user guide may include a method for minimizing a breakage of the display device. Specifically, the user guide may include a content for guiding the user to wipe the water spilled over the display device and not to press a button of the display device, and location information of a toll to wipe the water (e.g., a napkin, a towel, etc.). In addition, a user's behavior may be monitored using an external camera, and a result of the monitoring may be taken into consideration when calculating repair cost. If the user takes an action in accordance with the user guide, a time to reactivate the display device may be adjusted. At a time to reactivate the display device, in order to check whether the display device operates normally, a text guide screen may be displayed on the display device and the user may be guided to touch the screen, so that whether an output and a touch input of the display device operates normally can be checked.

The vehicle may calculate a cost for repairing the breakage of the display device and the side glass, displays the calculated repair costs on another display device an audio device for the user, and request agreement and approval on payment of the repair costs through the payment system. If the user does not agree with the request for the repair costs and performs an additional breakage leading behavior, a message indicative of a possible restriction on the use of the vehicle may be displayed and restrictions on a maximum speed, an available time to use, etc. of the vehicle may be set.

As described above, the autonomous vehicle may be used for a vehicle sharing service. In the vehicle sharing service, vehicle sharing types vary. Peer-to-Peer (P2P) vehicle sharing refers to a vehicle sharing type indicating a case where a vehicle owner and a vehicle user are connected to rent the vehicle to the user for a short period of time. Business-to-Customer (B2C) vehicle sharing refers to a vehicle sharing type indicating a case where a corporation possesses vehicles and service subscribing members are allowed to use sharing vehicles. Non-profit or cooperation (co-op) vehicle sharing refers to a vehicle sharing type in an organization or community, which focuses on providing social and environmental benefits so as to allow unused vehicles to be shared easily.

For a vehicle sharing service as shown above, there may be a server (or system) for managing sharing vehicles. The service may be substituted with another term such as a rent car operating server, a vehicle sharing operation server, a car sharing server, a vehicle rental server, etc. In addition, the server may be substituted with a term of system. Hereinafter, the server is referred to as the term of a vehicle sharing server, for convenience of explanation. For the sake of feet management of vehicles, the vehicle sharing server may include a server for managing and handling any vehicle breakage. Alternatively, a server for managing and handling a vehicle breakage may be operated independently of the vehicle sharing server. Hereinafter, for convenience of explanation, a server for managing and handling a vehicle breakage will be referred to as a vehicle breakage handling server.

Hereinafter, a method for monitoring a sharing vehicle using a vehicle breakage handling server and performing feet management, such as vehicle maintenance and repair, is proposed.

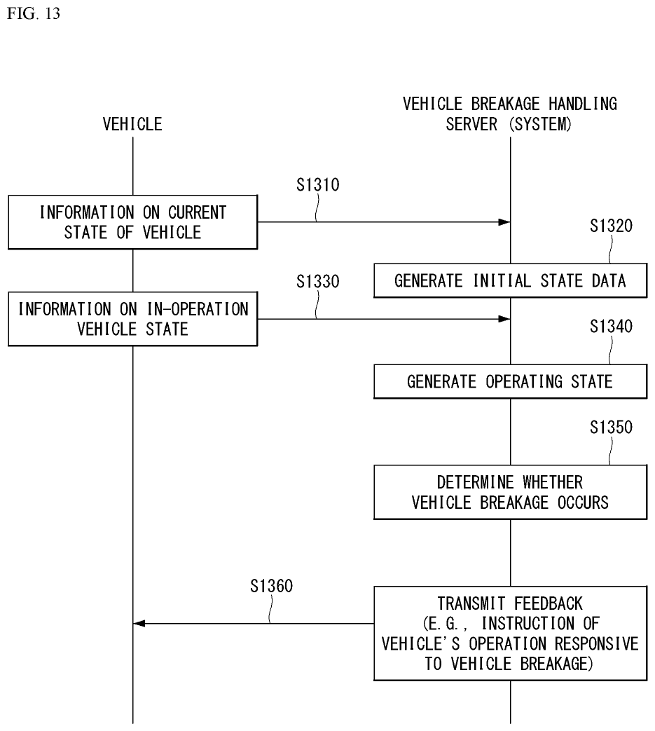

FIG. 13 shows an example of a flowchart of signaling and operations between a vehicle breakage handling server (or system), to which the method and the embodiment proposed in the present specification can be applied to, and a vehicle. FIG. 13 is merely an example for explanation of the present disclosure and does not limit the technical idea of the present disclosure.

Referring to FIG. 13, a vehicle breakage handling server may receive, from multiple vehicles, information on each vehicle's state prior to operation (S1310). The information on each vehicle's state prior to operation may include image data generated by a camera of a vehicle, data generated by a sensor of the vehicle, tec. The vehicle breakage handling server may generate initial state data on each vehicle's state prior to operation, based on the information on each vehicle's state prior to operation (S1320). The initial state data may indicate a corresponding vehicle's state prior to use of the vehicle by a user. The initial state data may be used as a basis of determining whether a vehicle breakage occurs. The initial state data may prove whether the vehicle was operable normally before the use, and may be used as an evidence to claim expense or compensation upon the occurrence of the breakage. The initial state data may be stored in a database system of the vehicle breakage handling server.

For example, image data of captured exterior and interior of a vehicle may be generated based on video data received from at least one of an internal camera or an external camera included in an imaging device of a cabin system of the vehicle. In addition, the vehicle breakage handling server may acquire information such as vehicle collision data, battery data, fuel data, tire pressure data, etc. using a sensing unit 270 of the vehicle, and may generate initial state data based on the acquired information. Alternatively, the vehicle breakage handling server may set the acquired image itself as initial state data.

The vehicle breakage handling server may transmit the initial state data to a user of a vehicle sharing service via a network connected to the vehicle. At this point, information on the user may be stored in a vehicle sharing server. A user may receive the initial state data of the vehicle using a user terminal (e.g., a mobile phone, a laptop computer, etc.), confirm a vehicle state, and use the vehicle. The confirmation by the user may be transmitted to the vehicle, the vehicle sharing server via the network connected to the vehicle.

The vehicle breakage handling server may receive information on a vehicle state during operation, which is required to monitor a broken state, from multiple vehicles (S1330). For example, information on a vehicle state during operation may be acquired using at least one of an object detection device 210 and a sensing unit 270 of a vehicle and an imaging device 320 of a cabin system 300.

The vehicle breakage handling server may generate operating state data based on the information on a vehicle state during operation (S1340). The operating state data may e generated based on information acquired by at least one device of an autonomous vehicle. The operating state data may be generated based on the information acquired in the step S1330. The operating state data may be stored in a database system of the vehicle breakage handling server.

The vehicle breakage handling server may update the operating state data periodically, semi-persistently, or asperiodically. In a case where the operating state information is updated periodically or semi-persistently, the operating state data may be updated by periodically or semi-persistently receiving a state of a vehicle in operation from the autonomous vehicle. In a case where the operating state data is updated aperiodically, the operating state data is updated by aperiodically receiving information on a state of a vehicle in operation from the autonomous vehicle.

In the case where the operating state information is updated aperiodically, the vehicle breakage handling server may receive a triggering signal in response to the update request from the autonomous vehicle. For example, when a breakage occurs while the vehicle is in operation, the vehicle breakage handling server may receive a signal (e.g., a breakage notifying emergency alarm, an ACK, etc.) indicative of an abnormal operation (e.g., a breakage) from the vehicle and may update the operating state data based on the state of the vehicle in operation. In this case, resources necessary to transmit and receive data between the vehicle and the vehicle breakage handling server may be utilized efficiently. In a specific example, when a collision with a nearby vehicle occurs while the vehicle is in operation, at least one device of the vehicle may recognize the collision and transmit an emergency alarm regarding the collision to the vehicle breakage handling server. The vehicle breakage handling server may update the operating state data based on data on situations before and after the collision, which is acquired using a camera included in the object detection device and/or the imaging device of the vehicle.

In addition, after termination of the operation of the vehicle, data corresponding to a state at a timing of when the operation of the vehicle is terminated may be generated using the object detection device 210 and the sensing unit 270 of the vehicle, the imaging device 320 of the cabin system 300, etc., and the operating state data may be updated based on the generated data. The operating state data at the operation termination timing may be used to calculate expense for use of a vehicle sharing service.

The vehicle breakage handling server may monitor whether a breakage occurs in the vehicle in operation, based on the generated initial state data and the operating state data. The vehicle breakage handling server may determine whether a breakage occurs in the vehicle, by comparing the initial state data and broken state data (S1350). The comparison between the initial state data and the operating state data may be performed whenever the operating state data is generated or updated. That is, the comparison between the initial state data and the operating state data may be performed periodically, semi-persistently, or aperiodically. Alternatively, the comparison between the initial state data and the operating state data may be performed when a triggering signal in response to an update request is received from the autonomous vehicle. In other words, although the operating state data is updated periodically, the initial state data and the operation state data can be compared when a signal indicative of an abnormal operation is received from a broken device.

When it is determined that a breakage occurs in the vehicle after the comparison between the initial state data and the operating state data, the vehicle breakage handling server may store data on comparison between the initial state data and the operating state data. Data including states before and after the breakage may be stored as breakage occurrence data so as to be used as an evidence to claim repair expense and determine responsibility for the breakage.

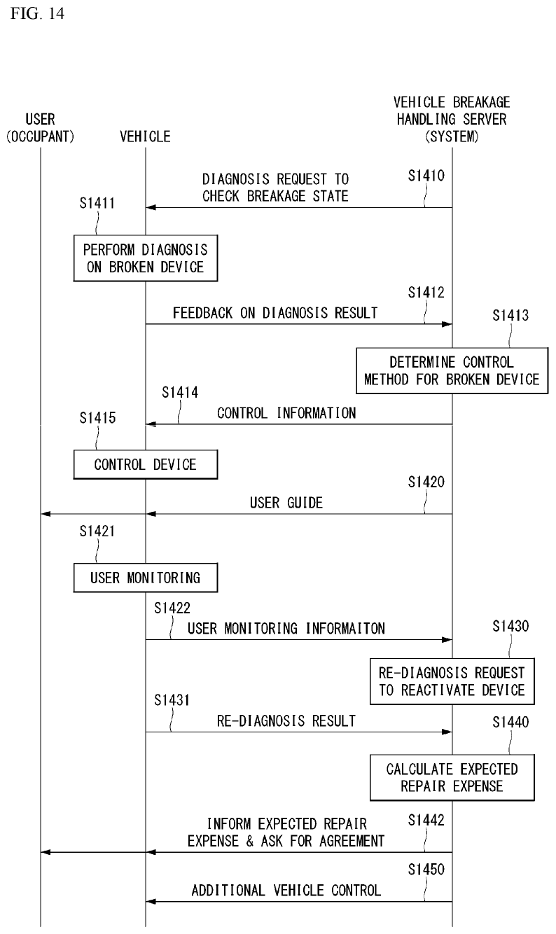

The vehicle breakage handling server may transmit a feedback to the vehicle based on a determination as to whether a breakage occurs in the vehicle (S1360). The feedback may include an instruction regarding an operation of the vehicle in response to the breakage in the vehicle. In other words, when it is determined that the vehicle is broken, a method for handling the breakage may be transmitted to the vehicle in order to avoid an additional breakage and minimize damage. A detailed description about the step S1360 will be provided with reference to FIG. 14.

Communication between the vehicle and the vehicle breakage handling server may be performed via a network connected to the vehicle. Specifically, the vehicle breakage handling server may transmit and receive data with the vehicle through at least one of a wireless communication network or a V2X network.

FIG. 14 shows an example of a flowchart in which a vehicle breakage handling server (or system), to which the method and the embodiment proposed in the present specification can be applied, instructs a vehicle to operate responsive to a vehicle breakage. FIG. 14 is an example for describing the step S1360 of FIG. 13 in detail. FIG. 14 is merely an example for providing a better understanding of the present disclosure, and it does not limit the technical idea of the present disclosure. Therefore, steps of operation of the vehicle breakage handling server may be replaced, omitted, or changed.

For example, referring to FIG. 14, when it is determined that a device (or component) in the vehicle is broken, a request for diagnosis of the corresponding broken device (or component) may be transmitted to the vehicle in order to check a state of the broken device (or component) (S1410). The vehicle may perform diagnosis on the broken device (or component) (S1411), and transmit a result of the diagnosis to the vehicle breakage server (S1412). The diagnosis of the broken device (or component) may be performed by the processor of an autonomous driving device or one of controllers of devices. Or, a controller of each device may perform primary diagnosis and the processor of the autonomous driving device may perform secondary diagnosis. Or, a diagnosing system (or device) for performing diagnosis on the broken device may exist independently in the autonomous driving device. At this point, the diagnosing system may perform diagnosis not just on the broken device (or component), but also on every function related to operations of the AVHS, such as sensor, recognition, determination, control, HMI, etc. Based on the result of the diagnosis, the vehicle breakage handling server may determine a control method for the broken device (or component) (S1413) and may transmit a control command (S1414). The vehicle may perform a control on the broken device (or component) in accordance of the control command from the vehicle breakage handling server (S1415).

In a specific example, when it is determined that the display device of the vehicle is broken, a request for diagnosis on the display device may be transmitted to the vehicle. The vehicle may perform diagnosis on the display device and transmit a result of the diagnosis to the server. Based on the result of the diagnosis, the vehicle breakage diagnosing server may determine whether to completely shut down power to the display device or whether to perform re-diagnosis after power shutdown for a predetermined period of time, may determine a method for controlling power to the display device, and may transmit a result of the determination to the vehicle. In accordance with a control command from the vehicle breakage handling server, the vehicle may shut down power to the display device.

\In another example, when it is determined that a device (or component) in the vehicle is broken, occurrence of the breakage may be notified to a user (occupant) and a breakage minimizing method (e.g., a user guide) may be transmitted to the vehicle in order to prevent an additional component breakage (S1420). The breakage minimizing method (e.g., a user guide) may be determined based on a result of the diagnosis. The breakage notification alarm and the user guide may be displayed through a display system 350 of the cabin system 300. Or, the breakage notification alarm and the user guide may be provided through an audio device in the vehicle. Or, the breakage notification alarm and the user guide may be provided through both the display device and the audio device.

When the vehicle breakage handling server transmits the user guide to the vehicle, the vehicle may monitor the user's responsive behavior in accordance with the user guide (S1421). Alternatively, the vehicle breakage handling server may transmit an instruction regarding user monitoring to the vehicle together with the user guide. The vehicle may perform monitoring of the user using the imaging device 320 of the cabin system. A result of the monitoring may be taken into consideration when expense for a broken device (or component) is calculated later. Specifically, an image of a user's behavior acquired using at least one camera of an internal camera or an external camera of the vehicle may be transmitted to the vehicle breakage handling server (S1422), and whether the user has taken a responsive action in accordance with the user guide may be determined based on the acquired image. When the user takes an appropriate action, expense deduction may be provided when expense for repairing the broken device is calculated. Alternatively, when the user takes an action in accordance to the user guide, the vehicle breakage handling server may transmit a re-diagnosis request to the vehicle (S1430). The vehicle may perform re-diagnosis on the broken device and provide a feedback on a result of the re-diagnosis (S1431), and determine whether to reactivate the component based on the feedback.

In another example, the vehicle breakage handling server may calculate expense for repairing the broke component (S1440) and transmit a payment request to the vehicle (S1442). The expense for repairing the broken component may be calculated based on an image and a diagnosis of the broken component. The vehicle may display repair expense information through the display system 350 of the cabin system 300. Or, the vehicle may provide the repair expense information through an audio device included in the vehicle. Or, the payment request may be forwarded by the vehicle to a user terminal. The forwarding may be performed via a network connected to the vehicle. Or, the vehicle breakage handling server (or a vehicle sharing server) may transmit a message for requesting payment of the repair expense to the user via a wireless communication network.

In addition, the vehicle may proceed to payment of the repair expense through the payment system 365. Specifically, the calculated repair expense may be displayed through the display device and a message to request agreement from the user may be displayed. When the user inputs an agreement message through the input device 310, the payment of the repair expense may be completed through the payment system. When the user does not agree with the payment of the repair expense for the vehicle breakage, the vehicle may transmit the user's disagreement to the vehicle, and the vehicle breakage handling server may transmit setting of restriction on use of the vehicle, such as restriction on a maximum speed of the vehicle, restriction on an available time to use, etc. (S1450).

The above-described vehicle breakage handling server may be configured as a part of the vehicle sharing server. Alternatively, the vehicle breakage handling server may be configured independently of a vehicle sharing server and operate in conjunction with the vehicle sharing server.

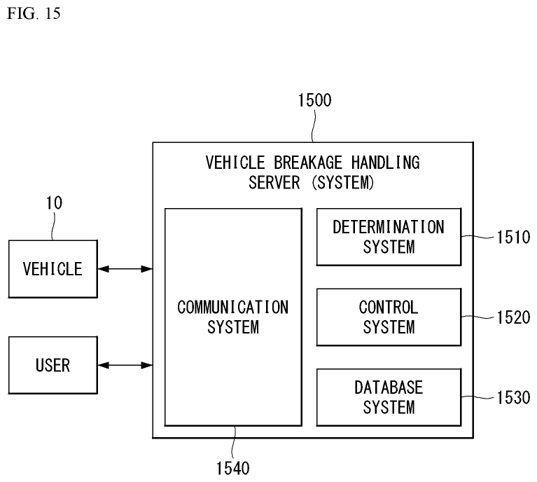

FIG. 15 is an example of a diagram showing a configuration of a vehicle breakage handling server to which the method and the embodiment proposed in the present specification can be applied. FIG. 15 is merely an example for explaining the present disclosure, and it does not limit the technical idea of the present disclosure.

Referring to FIG. 15, a vehicle breakage handling server 1500 may include a determination system 1510, a control system 1520, a database system 1530, and a communication system 1540 for communication with a vehicle and a user.

The database system 1530 may include the vehicle's initial state data, operating state data, breakage occurrence data, etc. Additionally, data on the vehicle's device (or component), user (occupant) information, etc. may be included.

The initial state data may indicate the vehicle's state prior to the occurrence of the breakage. The initial state data may prove that the vehicle's state prior to use was a normally operable state, and the initial state data may be used as an evidence to claim expense or compensation upon the breakage of the vehicle. In addition, the operating state data may be generated based on information on a vehicle state in operation acquired by at least one device of the vehicle. In addition, the operating state data may be updated periodically, semi-persistently, aperiodically. In addition, data on a state at an operation termination timing of the vehicle may be generated, and the operating state data may be updated based on the generated data. The operating state data may be used to calculate a fee for use of a vehicle sharing service and repair expense for a breakage of the vehicle. When the vehicle breakage handling server compares the initial state data and the operating state data and determines that a vehicle breakage occurs, data including states before and after the breakage may be stored as a breakage occurrence data so as to be used as an evidence to claim repair expense and determine responsibility for the breakage.

Data on a device (or component) of the vehicle may be used to calculate repair expense and provide a user guide when a breakage occurs in the device. User information may be used to manage customers of a vehicle sharing service, to charge for use of the service, to request payment of repair expense for breakage, to transmit relevant documents, etc.

The determination system 1510 may compare the initial state data and the operating state data in the database system to thereby determine whether a vehicle breakage occurs. In response to the vehicle breakage, the determination system may instruct an operation of the vehicle. In addition, repair expense for a broken device may be calculated. At this point, the repair expense may be calculated in consideration of a result of monitoring a user's behavior and the like.

In order to minimize a component breakage, the control system 1520 may determine a method for controlling a broken device and instruct a control method to the vehicle. Diagnosing the broken device may be instructed, and the broken device may be controlled based on a result of the diagnosis. In addition, if a user does not agree with a request for payment of repair expense for the broken device, restriction on use of the vehicle (e.g., a maximum speed, an available time to use, etc.) may be set. In addition, in order to generate operating state data, a control device may be transmitted to an in-vehicle device that acquires information on an in-operation state.

The communication system 1540 may perform data transmission and reception between the vehicle and the user. The communication system may perform communication based on at least one of a wireless communication network or a V2X network. For example, the vehicle breakage handling server may receive information acquired by at least one device of the vehicle through the communication system, and transmit control data, user guide, repair expense data, etc., to the vehicle.

Hereinafter, various embodiments for controlling a sharing vehicle in an Automated Vehicle and Highway System (AVHS) according to an embodiment of the present disclosure are described.

Embodiment 1: a method for monitoring a sharing vehicle by a server in an Automated Vehicle and Highway System (AVHS), the method including: generating initial state data on the sharing vehicle; generating operating state data on the sharing vehicle; determining as to whether the sharing vehicle is broken, by comparing the initial state data and the operating state data; and transmitting a feedback to the sharing vehicle based on the determination.

Embodiment 2: The method of Embodiment 1, further including receiving information on a state prior to operation from the sharing vehicle, wherein the information on the state prior to the operation may be acquired by at least one device of the sharing vehicle, and the initial state data is generated based on information on the state prior to the operation.

Embodiment 3: The method of Embodiment 1, further including receiving information on an in-operation state from the sharing vehicle, wherein the operating state data is generated based on the information on the in-operation state.

Embodiment 4: The method of Embodiment 1, further including: when a breakage occurs in the sharing vehicle, storing comparison data between the initial state data and the operating state data; and storing the comparison data.

Embodiment 5: The method of Embodiment 1, wherein, when it is determined that a breakage occurs in the sharing vehicle, the feedback comprises a request to diagnose a broken device.

Embodiment 6: The method of Embodiment 5, further including: receiving a diagnosis result in response to the request to diagnose the broken device; and, based on a result of the diagnosis, transmitting control information on the broken device to the sharing vehicle.

Embodiment 7: The method of Embodiment 5, wherein the feedback further includes a user guide regarding the broken device.

Embodiment 8: The method of Embodiment 7, further including receiving, from the sharing vehicle, data on monitoring as to whether a user takes an action in accordance with the user guide.

Embodiment 9: The method of Embodiment 8, wherein the data on the monitoring is used to calculate expense for the broken device.

Embodiment 10: The method of Embodiment 5, wherein the feedback further include a request to pay expense for the broken device.

Embodiment 11; The method of Embodiment 9, further including, when the request to pay the expense for the broken device is not approved, setting restriction on use of the sharing vehicle.

Embodiment 12: The method of Embodiment 1, wherein the sharing vehicle communicates with at least one of a mobile terminal, a network, or an autonomous vehicle other than the sharing vehicle.

Embodiment 13: A method for monitoring a sharing vehicle by the sharing vehicle in an Automated Vehicle and Highway System (AVHS), the method including: generating initial state data on the sharing vehicle; generating operating state data on the sharing vehicle; determining as to whether the sharing vehicle is broken, by comparing the initial state data and the operating state data; and transmitting a feedback to a user based on the determination.

Embodiment 14: The method of Embodiment 13, wherein the initial state data is generated based on information on a state prior to operation acquired by at least one device of the sharing vehicle.

Embodiment 15: The method of Embodiment 13, further including, when a breakage occurs in the sharing vehicle, storing comparison data between the initial state data and the operating state data.

Embodiment 16: The method of Embodiment 13, wherein when a breakage occurs in the sharing vehicle, storing comparison data between the initial state data and the operating state data.

Embodiment 17: The method of Embodiment 16, further including monitoring whether the user takes an action in accordance with the user guide.

Embodiment 18: The method of Embodiment 17, wherein data on the monitoring is used to calculate expense for the broken device.

Embodiment 19: The method of Embodiment 16, wherein the feedback further includes a request to pay expense for the broken device.

Embodiment 20: The method of Embodiment 19, further including, when the request to pay the expense for the broken device is not approved, setting restriction on use of the sharing vehicle.

Embodiment 21: A server for monitoring a sharing vehicle in an Automated Vehicle and Highway System (AVHS), the server including: a communication system configured to transmit and receive data with the sharing vehicle and a user; a database system configured to store initial state data and operating state data regarding the sharing vehicle, which is generated based on data received through the communication system; a determination system configured to determine whether the sharing vehicle is broken, by comparing the initial state data and the operating state data; and a control system for controlling a feedback on the sharing vehicle based on a result of the determination by the determination system.

Embodiment 22: The method of Embodiment 21, where information on a state prior to operation is received from the sharing vehicle through the communication system, the information on the state prior to the operation is acquired by at least one device of the sharing vehicle, and the initial state data is generated based on the information on the state prior to the operation.

Embodiment 23: The method of Embodiment 21, wherein, when the determination system determines that a breakage occurs in the sharing vehicle, comparison data between the initial state data and the operating state data is stored in the database system.

Embodiment 24: The method of Embodiment 21, wherein the feedback includes a request to diagnose a broken device.

Embodiment 25: The method of Embodiment 24, wherein a diagnosis result is further received in response to the request through the communication system, and the control system determines a control method for the broken device based on the diagnosis result and transmits the control method to the sharing vehicle through the communication system.

Embodiment 26: The method of Embodiment 24, wherein the feedback further includes a user guide regarding the broken device.

Embodiment 27: The method of Embodiment 26, wherein data on monitoring whether the user takes an action in accordance with the user guide is received from the sharing vehicle through the communication system.

Embodiment 28: The method of Embodiment 25, wherein the feedback further includes a request to pay expenses for the broken device.

Embodiment 29: The method of Embodiment 28, wherein, when the request to pay the expenses for the broken device is not approved, restriction on use of the sharing vehicle is set through the control system.

Embodiment 30: A device for monitoring a sharing vehicle in an Automated Vehicle and Highway System (AVHS), the device including: a communication device configured to communicate with another device; a memory configured to store data; and a processor functionally connected to the communication device and the memory, wherein the processor is configured to generate initial state data of the sharing vehicle, generate operating state data of the sharing vehicle, determine whether the sharing vehicle is broken by comparing the initial state data and the operating state data, and instruct operation of the sharing vehicle based on the determination.

Embodiment 31: The method of Embodiment 30, wherein, when it is determined that a breakage occurs in the sharing vehicle, comparison data between the initial state data and the operating state data is stored in the memory.

Embodiment 32: The method of Embodiment 30, wherein the initial state data is generated based on information on a state prior to operation, which is acquired by at least one device of the sharing vehicle.

Embodiment 33: The method of Embodiment 31, wherein displaying a user guide regarding a broken device through at least one device of the sharing vehicle is instructed.

Embodiment 34: The method of Embodiment 33, wherein the at least one device of the sharing vehicle is controlled to monitor whether a user takes an action in accordance with the user guide.

Embodiment 35: The method of Embodiment 33, wherein additionally displaying a request to pay expenses for the broken device is instructed.

According to the above-described methods and embodiments, when a vehicle is used for a vehicle sharing service in an Automated Vehicle and Highway System (AVHS), a situation where a breakage occurs may be recognized through monitoring an in-operation vehicle state, a vehicle control and a user guide and the like are provided to minimize damage to thereby reduce expenses to be paid by a user, and unnecessary conflicts between a vehicle owner and the user may be reduced.

The present disclosure described above may be implemented as a computer-readable code in a medium in which a program is recorded. The computer-readable medium includes any type of recording device in which data that can be read by a computer system is stored. The computer-readable medium may be, for example, a hard disk drive (HDD), a solid state disk (SSD), a silicon disk drive (SDD), a ROM, a RAM, a CD-ROM, a magnetic tape, a floppy disk, an optical data storage device, and the like. The computer-readable medium also includes implementations in the form of carrier waves (e.g., transmission via the Internet). Also, the computer may include the controller 180 of the terminal. Thus, the foregoing detailed description should not be interpreted limitedly in every aspect and should be considered to be illustrative. The scope of the present disclosure should be determined by reasonable interpretations of the attached claims and every modification within the equivalent range are included in the scope of the present disclosure.

### INDUSTRIAL APPLICABILITY

The present disclosure is described mainly about an example applicable to an Automated Vehicle and Highway System (AVHS) based on the fifth generation (5G) system, but the present disclosure can be applied to various wireless communication systems and an autonomous driving device.

1. A method for monitoring a sharing vehicle by a server in an Automated Vehicle and Highway System (AVHS), the method comprising:
generating initial state data on the sharing vehicle;
generating operating state data on the sharing vehicle;
determining that the sharing vehicle is broken, by comparing the initial state data and the operating state data; and
transmitting a feedback to the sharing vehicle based on the determination.

2. The method of claim 1, further comprising receiving information on a state prior to operation from the sharing vehicle,
wherein the information on the state prior to the operation is acquired by at least one device of the sharing vehicle, and the initial state data is generated based on information on the state prior to the operation.

3. The method of claim 1, further comprising receiving information on an in-operation state from the sharing vehicle,
wherein the operating state data is generated based on the information on the in-operation state.

4. The method of claim 1, further comprising:
when a breakage occurs in the sharing vehicle, storing comparison data between the initial state data and the operating state data; and
storing the comparison data.

5. The method of claim 1, wherein, when a breakage occurs in the sharing vehicle, the feedback comprises a request to diagnose a broken device.

6. The method of claim 5, further comprising:
receiving a diagnosis result in response to the request to diagnose the broken device; and
based on a result of the diagnosis, transmitting control information on the broken device to the sharing vehicle.

7. The method of claim 5, wherein the feedback further comprises a user guide regarding the broken device.

8. The method of claim 7, further comprising receiving, from the sharing vehicle, data on monitoring as to whether a user takes an action in accordance with the user guide.

9. The method of claim 8, wherein the data on the monitoring is used to calculate expense for the broken device.

10. The method of claim 5, wherein the feedback further comprises a request to pay expense for the broken device.

11. The method of claim 10, further comprising, when the request to pay the expense for the broken device is not approved, setting restriction on use of the sharing vehicle.

12. The method of claim 1, wherein the sharing vehicle communicates with at least one of a mobile terminal, a network, or an autonomous vehicle other than the sharing vehicle.

13. A method for monitoring a sharing vehicle by the sharing vehicle in an Automated Vehicle and Highway System (AVHS), the method comprising:
generating initial state data on the sharing vehicle;
generating operating state data on the sharing vehicle;
determining as to whether the sharing vehicle is broken, by comparing the initial state data and the operating state data; and
transmitting a feedback to a user based on the determination.

14. The method of claim 13, wherein the initial state data is generated based on information on a state prior to operation acquired by at least one device of the sharing vehicle.

15. The method of claim 13, further comprising, when a breakage occurs in the sharing vehicle, storing comparison data between the initial state data and the operating state data.

16. The method of claim 13, wherein the feedback comprises a user guide regarding a broken device.

17. The method of claim 16, further comprising monitoring whether the user takes an action in accordance with the user guide.

18. The method of claim 17, wherein data on the monitoring is used to calculate expense for the broken device.

19. The method of claim 16, wherein the feedback further comprises a request to pay expense for the broken device.

20. The method of claim 19, further comprising, when the request to pay the expense for the broken device is not approved, setting restriction on use of the sharing vehicle.
